(19) United States
(12) Patent Application Publication
(10) Pub. No.: US 2024/0002751 A1
(43) Pub. Date: Jan. 4, 2024

(54) CLEANING COMPOSITION

(71) Applicant: Conopco, Inc., d/b/a UNILEVER, Englewood Cliffs, NJ (US)

(72) Inventors: Nicholas Joseph BROWNBILL, Wirral (GB); Craig Jonathon FAIRGRIEVE, Birkenhead (GB); Neil James PARRY, Tarporley (GB); Paul Simon STEVENSON, Liverpool (GB)

(73) Assignee: Conopco, Inc., d/b/a UNILEVER, Englewood Cliffs, NJ (US)

(21) Appl. No.: 18/039,789

(22) PCT Filed: Dec. 10, 2021
(86) PCT No.: PCT/EP2021/085175

§ 371 Date: Jun. 1, 2023

(30) Foreign Application Priority Data
Dec. 17, 2020 (EP) 20214880.5

(51) Int. Cl. C11D 1/94; C11D 11/00

(52) U.S. Cl. CPC C11D 1/94; C11D 11/0029; C11D 1/146; C11D 11/0017; C11D 11/0035

(57) ABSTRACT

The invention relates to a cleaning composition comprising a) from 1 to 30 wt. % of a primary alkyl sulfate surfactant; b) from 1 to 10 wt. % of an amphoteric surfactant selected from betaines, glucamides and sultaines; and, c) from 1 to 10 wt. % of a rhamnolipid biosurfactant surfactant; wherein the ratio of primary alkyl sulfate surfactant to biosurfactant is from 8:1 to 1:10; and, wherein the ratio of primary alkyl sulfate surfactant to amphoteric surfactant is from 8:1 to 1:10; wherein the primary alkyl sulfate is a C₁₀-C₂₀ alkyl sulphate; to a method of treatment of a substrate; to a method of treatment of a textile; and to the use of a combination of a biosurfactant and amphoteric surfactant to improve the cold storage stability of primary alkyl sulfate containing formulations.

### FIELD OF INVENTION

The invention concerns a cleaning composition comprising a primary alkyl sulfate surfactant, an amphoteric surfactant and a biosurfactant surfactant.

### BACKGROUND OF THE INVENTION

Primary alkyl sulfate is an anionic surfactant, useful for cleaning purposes. There is a problem with these surfactants in terms of cold stability. The Krafft point of these materials is higher than would be perfect, for example sodium lauryl sulfate has a Krafft point of around 16° C. Below this point, the formulation containing these materials undergoes a phase change from soluble to insoluble, and the formulation becomes non-isotropic and milky in appearance. This is unacceptable to consumers.

The invention seeks to overcome the problem of cold stability of primary alkyl sulfate surfactant containing compositions.

### SUMMARY OF THE INVENTION

We have found that cleaning compositions containing a primary alkyl sulfate surfactant have improved stability at cold temperatures by inclusion of a combination of an amphoteric surfactant and a rhamnolipid surfactant.

The invention relates in a first aspect to a cleaning composition comprising:
a) from 1 to 30 wt. % of a primary alkyl sulfate surfactant;
b) from 1 to 10 wt. % of an amphoteric surfactant selected from betaines, glucamides and sultaines; and,
c) from 1 to 10 wt. % of a rhamnolipid biosurfactant surfactant;
   wherein the ratio of primary alkyl sulfate surfactant to biosurfactant is from 8:1 to 1:10, preferably from 7:1 to 1:5, more preferably from 6:1 to 1:2, even more preferably from 6:1 to 1:1; and,
   wherein the ratio of primary alkyl sulfate surfactant to amphoteric surfactant is from 8:1 to 1:10, preferably from 7:1 to 1:5, more preferably from 6:1 to 1:2, even more preferably from 6:1 to 1:1;

wherein the primary alkyl sulfate is a C₁₀-C₂₀ alkyl sulphate.

Preferably the cleaning composition is a fluid cleaning composition, more preferably an aqueous cleaning composition.

Preferably the cleaning composition comprises from 1 to 25 wt. %, preferably from 2.5 to 20 wt. %, most preferably from 2.5 to 15 wt. % of primary alkyl sulfate.

Preferably the primary alkyl sulfate is a sodium, potassium or ammonium C₁₀-C₂₀ alkyl sulphate, even more preferably sodium C₁₀-C₂₀ alkyl sulphate, most preferably sodium lauryl sulfate.

Preferably the cleaning composition comprises from 1 to 9 wt. %, preferably from 1 to 8 wt. %, most preferably from 1.5 to 6 wt. % of a rhamnolipid biosurfactant.

Preferably, the rhamnolipid biosurfactant comprises at least 50 wt. % mono-rhamnolipid, more preferably at least 60 wt. % mono-rhamnolipid, even more preferably 70 wt. % mono-rhamnolipid, most preferably at least 80 wt. % mono-rhamnolipid, or wherein the rhamnolipid comprises at least 50 wt. % di-rhamnolipid, more preferably at least 60 wt. % di-rhamnolipid, even more preferably 70 wt. % di-rhamnolipid, most preferably at least 80 wt. % di-rhamnolipid.

Preferably the rhamnolipid biosurfactant is a di-rhamnolipid of formula: Rha2C₈₋₁₂C₈₋₁₂, wherein the alkyl chain may be saturated or unsaturated.

Preferably the cleaning composition comprises from 1 to 9 wt. %, preferably from 1 to 8 wt. %, most preferably from 1.5 to 6 wt. % of amphoteric surfactant selected from betaines, glucamides and sultaines.

Preferably the amphoteric surfactant is selected from cocamidopropyl betaine and lauryl hydroxy sultaine, most preferably the amphoteric surfactant is lauryl hydroxy sultaine.

Preferably the composition is a home care cleaning composition.

Preferably the composition further comprises one or more enzymes selected from lipases, proteases, amylases, cellulases, and mixtures thereof.

Preferably the detergent composition when dissolved in demineralised water at 4 g/L, 293K, has a pH of from 4 to 11, more preferably from 5 to 10, even more preferably from 5 to 9.

Preferably the cleaning composition is a laundry detergent composition, more preferably a liquid laundry detergent or a powder detergent. Preferably when a liquid detergent, the laundry detergent composition when dissolved in demineralised water at 4 g/L, 293K, has a pH of from 6 to 11, more preferably from 7 to 9.

The invention further relates in a second aspect to a method of cleaning a substrate, the method comprising the steps of:
a) treating said substrate with an aqueous solution of the cleaning composition as defined in the first aspect; and,
b) rinsing and drying the substrate.

Preferably the substrate is selected from cutlery, crockery, glassware, plastics and metal.

The invention further relates in a third aspect to a domestic method of treating a textile, the method comprising the steps of:
a) treating a textile with from 1 g/L of an aqueous solution of the cleaning composition as defined in the first aspect; and,
b) allowing said aqueous solution to remain in contact with the textile for a time period of from 10 minutes to 2 days, then rinsing and drying the textile.

The invention further relates in a fourth aspect to the use of a combination of a rhamnolipid biosurfactant, and amphoteric surfactant selected from betaines, glucamides and sultaines, to improve the cold storage stability of primary alkyl sulfate containing formulations, at temperatures below 11° C., more preferably at temperatures below 10° C., more preferably at temperatures below 5° C.

It is intended that any preferable subject matter described herein can be combined with any other subject matter, particularly combining 2 or more preferable subject matters.

### DETAILED DESCRIPTION OF THE INVENTION

Primary Alkyl Sulfate

The cleaning composition comprises from 1 to 30 wt. %, preferably from 1 to 25 wt. %, preferably from 2.5 to 20 wt. %, most preferably from 2.5 to 15 wt. % of primary alkyl sulfate.

The primary alkyl sulfate is a C₁₀-C₂₀ alkyl sulphate, preferably a lauryl sulfate.

The primary alkyl sulfate preferably is in the form with a counterion, more preferably the counterion is a sodium, potassium or ammonium ion.

Examples of preferred materials include sodium C₁₀-C₂₀ alkyl sulphate, most preferably sodium lauryl sulfate.

The primary alkyl sulphate does not include alkoxylated sulphates, i.e. the term primary alkyl sulphate does not include primary ether sulphates.

The ratio of primary alkyl sulfate surfactant to biosurfactant, preferably microbial derived biosurfactant, most preferably rhamnolipid biosurfactant is from 8:1 to 1:10, preferably from 7:1 to 1:5, more preferably from 6:1 to 1:2, even more preferably from 6:1 to 1:1.

The ratio of primary alkyl sulfate surfactant to amphoteric surfactant is from 8:1 to 1:10, preferably from 7:1 to 1:5, more preferably from 6:1 to 1:2, even more preferably from 6:1 to 1:1.

The ratios of primary alkyl sulfate surfactant to amphoteric surfactant and the ratio of primary alkyl sulfate surfactant to biosurfactant, preferably microbial derived biosurfactant, most preferably rhamnolipid biosurfactant can each individually or together also preferably go from to 1:1, preferably from 4:1 to 1:1, more preferably from 3:1 to 1:1 most preferably from 2.75:1 to 1:1, or even 2.5 to 1:1.

Biosurfactant

Preferably the rhamnolipid biosurfactant is present in the formulation from 1 to 9 wt. %, more preferably from 1 to 8 wt. %, most preferably from 1.5 to 6 wt. %.

The biosurfactant are rhamnolipids. These are a class of glycolipid. They are constructed of rhamnose combined with beta-hydroxy fatty acids. Rhamnose is a sugar. Fatty acids are ubiquitous in animals and plants.

Rhamnolipids are discussed in Applied Microbiology and Biotechnology (2010) 86:1323-1336 by E. Deziel et al. Rhamnolipids are produced by Evonik, Stepan, Glycosurf, AGAE Technologies and Urumqi Unite Bio-Technology Co., Ltd. Rhamnolipids may be produced by strains of the bacteria Pseudomonas Aeruginosa. There are two major groups of rhamnolipids; mono-rhamnolipids and di-rhamnolipids.

Mono-rhamnolipids have a single rhamnose sugar ring. A typical mono-rhamnolipid produced by P. aeruginosa is L-rhamnosyl-β-hydroxydecanoyl-β-hydroxydecanoate (RhaC₁₀C₁₀). It may be referred to as Rha-C₁₀-C₁₀, with a formula of C₂₆H₄₈O₉. Mono-rhamnolipids have a single rhamnose sugar ring.

The IUPAC Name is 3-[3-[(2R,3R,4R,5R,6S)-3,4,5-trihydroxy-6-methyloxan-2-yl]oxydecanoyloxy]decanoic acid.

Di-rhamnolipids have two rhamnose sugar rings. A typical di-rhamnolipid is L-rhamnosyl-L-rhamnosyl-8-hydroxydecanoyl-8-hydroxydecanoate (Rha2C₁₀C₁₀). It may be referred to as Rha-Rha-C-₁₀-C-₁₀, with a formula of C₃₂H₅₈O₁₃.

The IUPAC name is 3-[3-[4,5-dihydroxy-6-methyl-3-(3,4,5-tri hydroxy-6-methyloxan-2-yl)oxyoxan-2-yl]oxydecanoyloxy]decanoic acid.

In practice a variety of other minor components with different alkyl chain length combinations, depending upon carbon source and bacterial strain, exist in combination with the above more common rhamnolipids. The ratio of mono-rhamnolipid and di-rhamnolipid may be controlled by the production method. Some bacteria only produce mono-rhamnolipid, see U.S. Pat. No. 5,767,090: Example 1, some enzymes can convert mono-rhamnolipid to di-rhamnolipid.

In various publications mono-rhamnolipids have the notation Rha-, which may be abbreviated as Rh or RL2. Similarly, di-rhamnolipids have the notation Rha-Rha or Rh-Rh-35 or RL1. For historical reasons “rhamnolipid 2” is a mono-rhamnolipid and “rhamnolipid 1” is a di-rhamnolipid. This leads to some ambiguity in the usage or “RL1” and “RL2” in the literature.

Throughout this patent specification, we use the terms mono- and di-rhamnolipid in order to avoid this possible confusion. However, if abbreviations are used R1 is mono-rhamnolipid and R2 is di-rhamnolipid. For more information on the confusion of terminology in the prior art see the introduction to U.S. Pat. No. 4,814,272.

The following rhamnolipids have been detected as produced by the following bacteria: (C12:1, C14:1 indicates fatty acyl chains with double bonds).

Rhamnolipids produced by P. aeruginosa (mono-rhamnolipids):

Rha-C8-C10, Rha-C10-C8, Rha-C-10-C10, Rha-C10-C12, Rha-C10-C12:1, Rha-C12-C10, Rha-C12:1-C10

Rhamnolipids produced by P. aeruginosa (di-rhamnolipids):

Rha-Rha-C8-C10, Rha-Rha-C8-C12:1, Rha-Rha-C10-C8, Rha-Rha-C10-C10, Rha-Rha-010-012:1, Rha-Rha-C-10-C-12, Rha-Rha-C-12-C-10, Rha-Rha-C-12:1-C-12, Rha-Rha-C-10-C14:1.

Rhamnolipids produced by P. aeruginosa (unidentified as either mono- or di-rhamnolipids): C8-C8, C8-C10, C10-C8, C8-C12:1, C12:1-C8, C10-010, C12-C10, C12:1-C10 C12-C12, C12:1-C12, C14-C10, C14:1-C10, C14-C14.

Rhamnolipids produced by P. chlororaphis (mono-rhamnolipids only):

Rha-C10-C8, Rha-C10-C10, Rha-C12-C10, Rha-C12:1-C10, Rha-C12-C12, Rha-C12:1-C12, Rha-C14-C10. Rha-C-14:1-C-10.

Rhamnolipids produced by Burkholdera pseudomallei (di-rhamnolipids only):

Rha-Rha-C14-C14.

Rhamnolipids produced by Burkholdera (Pseudomonas) plantarii (di-rhamnolipids only):

Rha-Rha-C14-C14.

There are over 100 strains of P. aeruginosa on file at the American Type Culture Collection (ATCC). There are also a number of strains that are only available to manufacturers of commercial Rhamnolipids. Additionally there are probably thousands of strains isolated by various research institutions around the world. Some work has gone into typing them into groups. Each strain has different characteristics including how much rhamnolipid is produced, which types of rhamnolipids are produced, what it metabolizes, and conditions in which it grows. Only a small percentage of the strains have been extensively studied.

Through evaluation and selection, strains of P. aeruginosa can be isolated to produce rhamnolipids at higher concentrations and more efficiently. Strains can also be selected to produce less byproduct and to metabolize different feedstock or pollutants. This production is greatly affected by the environment in which the bacterium is grown.

A typical di-rhamnolipid is L-rhamnosyl-L-rhamnosyl-β-hydroxydecanoyl-β-hydroxydecanoate (Rha2C₁₀C₁₀ with a formula of C₃₂H₅₈O₁₃).

In practice a variety of other minor components with different alkyl chain length combinations, depending upon carbon source and bacterial strain, exist in combination with the above more common rhamnolipids. The ratio of mono-rhamnolipid and di-rhamnolipid may be controlled by the production method. Some bacteria only produce mono-rhamnolipid, see U.S. Pat. No. 5,767,090: Example 1, some enzymes can convert mono-rhamnolipid to di-rhamnolipid.

Preferably the rhamnolipid is selected from: Rhamnolipids produced by P. aeruginosa (mono-rhamnolipids):
Rha-C8-C10, Rha-C10-C8, Rha-C10-C10, Rha-C10-C12, Rha-C10-C12:1, Rha-C12-C10, Rha-C12:1-C10
Rhamnolipids produced by P. chlororaphis (mono-rhamnolipids only): Rha-C10-C8, Rha-C10-C10, Rha-C12-C10, Rha-C12:1-C10, Rha-C12-C12, Rha-C12:1-C12, Rha-C14-C10, Rha-C14:1-C10.
Mono-rhamnolipids may also be produced from P.putida by introduction of genes rhIA and rhIB from Psuedomonas aeruginosa [Cha et al. in Bioresour Technol. 2008. 99(7):2192-9]
Rhamnolipids produced by P. aeruginosa (di-rhamnolipids):

Rha-Rha-C8-C10, Rha-Rha-C8-C12:1, Rha-Rha-C10-C8, Rha-Rha-C10-C10, Rha-Rha-010-012:1, Rha-Rha-C10-C12, Rha-Rha-C12-C10, Rha-Rha-C12:1-C12, Rha-Rha-C10-C14:1
Rhamnolipids produced by Burkholdera pseudomallei (di-rhamnolipids only): Rha-Rha-C14-C14.
Rhamnolipids produced by Burkholdera (Pseudomonas) plantarii (di-rhamnolipids only): Rha-Rha-C14-C14.
Rhamnolipids produced by P. aeruginosa which are initially unidentified as either mono- or di-rhamnolipids:

C8-C8, C8-C10, C10-C8, C8-C12:1, C12:1-C8, C10-010, C12-C10, C12:1-C10, C12-C12, C12:1-C12, C14-C10, C14:1-C10, C14-C14.

Most preferably the Rhamnolipid is L-rhamnosyl-p-hydroxydecanoyl-p-hydroxydecanoate (RhaC₁₀C₁₀ with a formula of C₂₆H₄₈O₉) produced by P. aeruginosa.

Preferably, the rhamnolipid comprises at least 50 wt. % mono-rhamnolipid, more preferably at least 60 wt. % mono-rhamnolipid, even more preferably 70 wt. % mono-rhamnolipid, most preferably at least 80 wt. % mono-rhamnolipid; alternatively, wherein the rhamnolipid comprises at least 50 wt. % di-rhamnolipid, more preferably at least 60 wt. % di-rhamnolipid, even more preferably 70 wt. % di-rhamnolipid, most preferably at least 80 wt. % di-rhamnolipid.

Preferably the rhamnolipid is a di-rhamnolipid of formula: Rha2C₈₋₁₂ C₈₋₁₂. The preferred alkyl chain length is from C₈ to C₁₂. The alkyl chain may be saturated or unsaturated.

Amphoteric Surfactant The surfactant combination comprises from 1 to 10 wt. % of an amphoteric (also known as zwitteronic) surfactant.

Preferably the cleaning composition comprises from 1 to 9 wt. %, preferably from 1 to 8 wt. %, most preferably from 1.5 to 6 wt. % of amphoteric surfactant.

The amphoteric surfactant is selected from betaines, glucamides and sultaines, preferably selected from cocamidopropyl betaine and lauryl hydroxy sultaine, most preferably the amphoteric surfactant is lauryl hydroxy sultaine.

Cleaning Composition

The composition is a cleaning composition, useful for cleaning a substrate, for example a surface, including for home and personal care purposes. The composition is preferably a fluid cleaning composition, more preferably an aqueous cleaning composition.

Preferably the cleaning composition is a home care composition.

Such a composition could be used for example for hand dish wash, to cleaning substrates such as cutlery, crockery, glassware, plastics and metal.

Such a composition could be used for example for laundry purposes, to launder textile articles.

Preferably the cleaning composition is a laundry detergent composition, more preferably a liquid laundry detergent or a powder detergent.

Ph

Preferably the detergent composition when dissolved in demineralised water at 4 g/L, 293K, has a pH of from 4 to 11, more preferably from 5 to 10, even more preferably from 5 to 9.

25 Preferably when a liquid laundry detergent, the laundry detergent composition when dissolved in demineralised water at 4 g/L, 293K, has a pH of from 6 to 11, more preferably from 6 to 9.

Additional Surfactants

Additional surfactants may be present in the composition.

Preferably the cleaning composition comprises from 0 to 20 wt. %, more preferably from 0 to 10 wt. % of additional surfactants.

These are preferably selected from anionic and nonionic surfactants.

In general, the nonionic and anionic surfactants of the surfactant system may be chosen from the surfactants described “Surface Active Agents” Vol. 1, by Schwartz & Perry, lnterscience 1949, Vol. 2 by Schwartz, Perry & Berch, lnterscience 1958, in the current edition of “McCutcheon's Emulsifiers and Detergents” published by Manufacturing Confectioners Company or in “Tenside-Taschenbuch”, H. Stache, 2nd Edn, Carl Hauser Verlag, 1981. Preferably the surfactants used are saturated.

Preferred nonionic detergent compounds which may be used include the reaction products of compounds having a hydrophobic group and a reactive hydrogen atom, for example, aliphatic alcohols, acids, amides with alkylene oxides, especially ethylene oxide either alone or with propylene oxide. Specific nonionic detergent compounds are the condensation products of aliphatic primary or secondary linear or branched alcohols with ethylene oxide, generally 5 to 40 EO, preferably 7EO to 9EO.

Preferred anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl C₁₀ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁ to C₁₅ alkyl benzene sulphonates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials.

Preferably the additional surfactant is predominately anionic surfactant by weight.

Cleaning Boosters

Cleaning boosters may preferably be present in the composition.

The composition preferably comprises from 0.5 to 15 wt. %, more preferably from 0.75 to 15 wt. %, even more preferably from 1 to 12 wt. %, most preferably from 1.5 to 10 wt. % of cleaning boosters selected from antiredeposition polymers; soil release polymers; alkoxylated polycarboxylic acid esters as described in WO 2019/008036 and WO 2019/007636; and mixtures thereof.

Antiredeposition Polymers

Preferred antiredeposition polymers include alkoxylated polyamines.

A preferred alkoxylated polyamine comprises an alkoxylated polyethylenimine, and/or alkoxylated polypropylenimine. The polyamine may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25. A preferred material is ethoxylated polyethyleneimine, with an average degree of ethoxylation being from to 30 preferably from 15 to 25, where a nitrogen atom is ethoxylated.

Soil Release Polymer

Preferably the soil release polymer is a polyester soil release polymer.

Preferred soil release polymers include those described in WO 2014/029479 and WO 2016/005338.

Preferably the polyester based soil release polymer is a polyester according to the following formula (I)

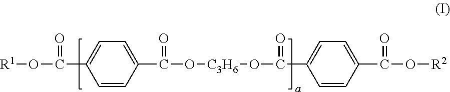

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OC₃H₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9.

Preferably the polyester provided as an active blend comprising:
A) from 45 to 55% by weight of the active blend of one or more polyesters according to the following formula (I)

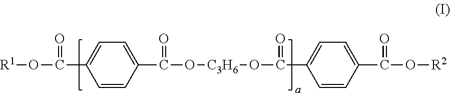

wherein
R1 and R2 independently of one another are X—(OC₂H₄)ₙ—(OC₃H₆)ₘ wherein X is C₁₋₄ alkyl and preferably methyl, the —(OC₂H₄) groups and the —(OC₃H₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9 and
B) from 10 to 30% by weight of the active blend of one or more alcohols selected from the group consisting of ethylene glycol, 1,2-propylene glycol, 1,3-propylene glycol, 1,2-butylene glycol, 1,3-butylene glycol, 1,4-butylene glycol and butyl glycol and
C) from 24 to 42% by weight of the active blend of water.

Alkoxylated Polycarboxylic Acid Esters

Alkoxylated polycarboxylic acid esters are obtainable by first reacting an aromatic polycarboxylic acid containing at least three carboxylic acid units or anhydrides derived therefrom, preferably an aromatic polycarboxylic acid containing three or four carboxylic acid units or anhydrides derived therefrom, more preferably an aromatic polycarboxylic acid containing three carboxylic acid units or anhydrides derived therefrom, even more preferably trimellitic acid or trimellitic acid anhydride, most preferably trimellitic acid anhydride, with an alcohol alkoxylate and in a second step reacting the resulting product with an alcohol or a mixture of alcohols, preferably with C16/C18 alcohol.

Further Ingredients

The cleaning composition may comprise any of these further preferred ingredients.

One or more of these further ingredients are particularly useful to include if the cleaning composition is a home care composition, particularly if it is a for a hand dish wash or laundry purpose.

Builders or Complexing Agents

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

The composition may also contain 0-65% of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (including bicarbonate and sesquicarbonate) are preferred builders.

The composition may contain as builder a crystalline aluminosilicate, preferably an alkali metal aluminosilicate, more preferably a sodium aluminosilicate. This is typically present at a level of less than 15 wt. %. Aluminosilicates are materials having the general formula:

0.8-1.5M₂₀·Al₂O₃·0.8-6 SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

Preferably the laundry detergent formulation contains less than 1 wt. % of phosphate. Preferably the laundry detergent formulation is carbonate built if a builder is included.

Fluorescent Agent

The composition preferably comprises a fluorescent agent (optical brightener).

Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt. %, more preferably 0.01 to 0.1 wt. %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl. It is preferred that the aqueous solution used in the method has a fluorescer present. When a fluorescer is present in the aqueous solution used in the method it is preferably in the range from 0.0001 g/I to 0.1 g/I, preferably 0.001 to 0.02 g/I.

Dye

The composition preferably comprises a dye. Dyes are discussed in K.Hunger (ed). Industrial Dyes: Chemistry, Properties, Applications (Weinheim: Wiley-VCH 2003). Organic dyes are listed in the colour index (Society of Dyers and Colourists and the American Association of Textile Chemists and Colorists)

Preferred dye chromophores are azo, azine, anthraquinone, phthalocyanine and triphenylmethane.

Azo, anthraquinone, phthalocyanine and triphenylmethane dyes preferably carry a net anionic charged or are uncharged. Azine dyes preferably carry a net anionic or cationic charge.

Preferred non-shading dyes are selected are selected from blue dyes, most preferably anthraquinone dyes bearing sulphonate groups and triphenylmethane dye bearing sulphonate groups. Preferred compounds are acid blue 80, acid blue 1, acid blue 3; acid blue 5, acid blue 7, acid blue 9, acid blue 1 1, acid blue 13, acid blue 15, acid blue 17, acid blue 24, acid blue 34, acid blue 38, acid blue 75, acid blue 83, acid blue 91, acid blue 97, acid blue 93, acid blue 93:1, acid blue 97, acid blue 100, acid blue 103, acid blue 104, acid blue 108, acid blue 109, acid blue 1 10, and acid blue 213. On dissolution granules with non-shading dyes provide an attractive colour to the wash liquor.

Blue or violet Shading dyes are most preferred. Shading dyes deposit to fabric during the wash or rinse step of the washing process providing a visible hue to the fabric. In this regard the dye gives a blue or violet colour to a white cloth with a hue angle of 240 to 345, more preferably 260 to 320, most preferably 270 to 300. The white cloth used in this test is bleached non-mercerised woven cotton sheeting.

Shading dyes are discussed in WO 2005/003274, WO 2006/032327(Unilever), WO 2006/032397(Unilever), WO 2006/045275(Unilever), WO 2006/027086(Unilever), WO 2008/017570(Unilever), WO 2008/141880(Unilever), WO 2009/132870(Unilever), WO 2009/141 173 (Unilever), WO 2010/099997(Unilever), WO 2010/102861 (Unilever), WO 2010/148624(Unilever), WO 2008/087497 (P&G), WO 2011/011799 (P&G), WO 2012/054820 (P&G), WO 2013/142495 (P&G) and WO 2013/151970 (P&G).

A mixture of shading dyes may be used.

The shading dye chromophore is most preferably selected from mono-azo, bis-azo, anthraquinone, and azine.

Mono-azo dyes preferably contain a heterocyclic ring and are most preferably thiophene dyes. The mono-azo dyes are preferably alkoxylated and are preferably uncharged or anionically charged at pH=7. Alkoxylated thiophene dyes are discussed in WO 2013/142495 and WO 2008/087497.

Most preferred shading dyes are selected from Direct Violet 9, Direct Violet 99, Direct Violet 35, Solvent Violet 13, Disperse Violet 28, dyes of the structure

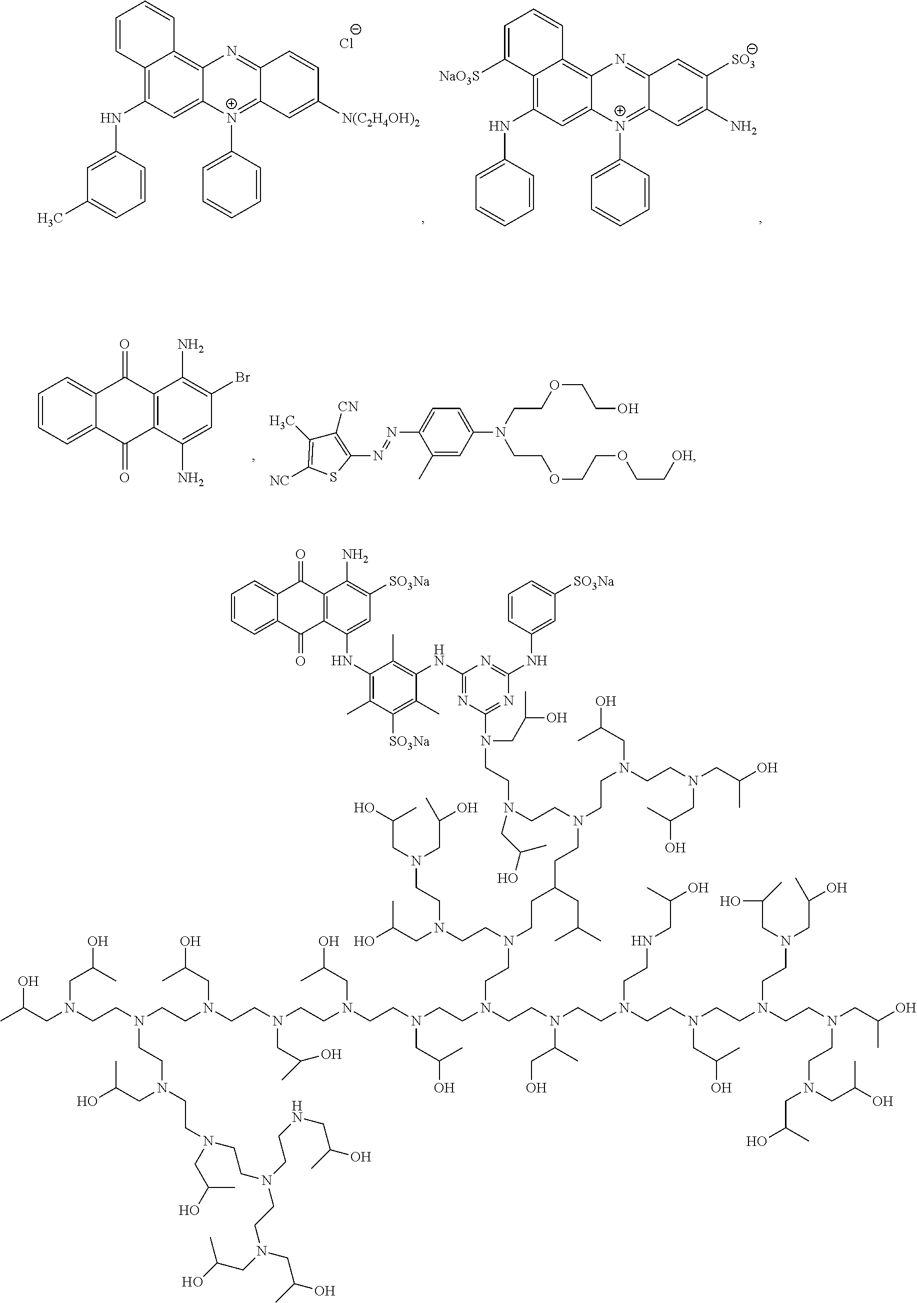

Perfume

Preferably the composition comprises a perfume. The perfume is preferably in the range from 0.001 to 3 wt. %, most preferably 0.1 to 1 wt. %. Many suitable examples of perfumes are provided in the CTFA (Cosmetic, Toiletry and Fragrance Association) 1992 International Buyers Guide, published by CFTA Publications, and OPD 1993 Chemicals Buyers Directory Annual Edition, published by Schnell Publishing Co.

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt. % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

It is preferred that the laundry treatment composition does not contain a peroxygen bleach, e.g., sodium percarbonate, sodium perborate, and peracid.

Polymers

The composition may comprise one or more further polymers. Examples are carboxymethylcellulose, poly(ethylene glycol), polyvinyl alcohol), polycarboxylates such as polyacrylates, maleic/acrylic acid copolymers and lauryl methacrylate/acrylic acid copolymers. Polymers present to prevent dye deposition, for example poly(vinylpyrrolidone), poly(vinylpyridine-N-oxide), and poly(vinylimidazole), may be present in the formulation.

Enzymes

One or more enzymes are preferred to be present in a cleaning composition of the invention and when practicing a method of the invention.

Preferably the level of each enzyme in the composition of the invention is from 0.0001 wt. % to 0.1 wt. % protein.

Especially contemplated enzymes include proteases, alpha-amylases, cellulases, lipases, peroxidases/oxidases, pectate lyases, and mannanases, or mixtures thereof.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO and WO 96/27002), P. wisconsinensis (WO 96/12012), a Bacillus lipase, e.g. from B. subtilis (Dartois et al. (1993), Biochemica et Biophysica Acta, 1 131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202, WO 00/60063.

Preferred commercially available lipase enzymes include Lipolase™ and Lipolase Ultra™′ Lipex™ and Lipoclean™ (Novozymes A/S).

The method of the invention may be carried out in the presence of phospholipase classified as EC3.1.1.4 and/or EC3.1.1 0.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases Ai and A2 which hydrolyze one fatty acyl group (in the sn-1 and sn-2 position, respectively) to form lysophospholipid; and lysophospholipase (or phospholipase B) which can hydrolyze the remaining fatty acyl group in lysophospholipid.

Phospholipase C and phospholipase D (phosphodiesterases) release diacyl glycerol or phosphatidic acid respectively.

The enzyme and the photobleach may show some interaction and should be chosen such that this interaction is not negative. Some negative interactions may be avoided by encapsulation of one or other of enzyme or photobleach and/or other segregation within the product.

Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Preferred commercially available protease enzymes include Alcalase™, Savinase™, Primase™, Duralase™, Dyrazym™, Esperase™, Everlase™, Polarzyme™, and Kannase™, (Novozymes A/S), Maxatase™, Maxacal™, Maxapem™, Properase™, Purafect™, Purafect OxP™, FN2™, and FN3™ (Genencor International Inc.).

The method of the invention may be carried out in the presence of cutinase classified in EC 3.1.1 0.74. The cutinase used according to the invention may be of any origin.

Preferably cutinases are of microbial origin, in particular, of bacterial, of fungal or of yeast origin.

Suitable amylases (alpha and/or beta) include those of bacterial or fungal origin.

Chemically modified or protein engineered mutants are included. Amylases include, for example, alpha-amylases obtained from Bacillus, e.g. a special strain of B. lichen iformis, described in more detail in GB 1,296,839, or the Bacillus sp. strains disclosed in WO or WO 00/060060. Commercially available amylases are Duramyl™ Termamyl™ Termamyl Ultra™, Natalase™, Stainzyme™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. Nos. 4,435,307, 5,648,263, 5,691,178 , 5,776,757, WO 89/09259, WO 96/029397, and WO 98/012307.

Commercially available cellulases include Celluzyme™, Carezyme™ Celluclean™.

Endolase™, Renozyme™ (Novozymes A/S), Clazinase™ and Puradax HA™ (Genencor International Inc.), and KAC-500(B)™ (Kao Corporation).

Suitable peroxidases/oxidases include those of plant, bacterial or fungal origin.

Chemically modified or protein engineered mutants are included. Examples of useful peroxidases include peroxidases from Coprinus, e.g. from C. cinereus, and variants thereof as those described in WO 93/24618, WO 95/10602, and WO 98/15257.

Commercially available peroxidases include Guardzyme™ and Novozym™ 51004 (Novozymes A/S).

Further enzymes suitable for use are discussed in WO 2009/087524, WO 2009/090576, WO 2009/107091, WO 2009/111258 and WO 2009/148983.

Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

Where alkyl groups are sufficiently long to form branched or cyclic chains, the alkyl groups encompass branched, cyclic and linear alkyl chains. The alkyl groups are preferably linear or branched, most preferably linear.

The indefinite article “a” or “an” and its corresponding definite article “the” as used herein means at least one, or one or more, unless specified otherwise.

The invention will be further described with the following non-limiting examples.

### EXAMPLES

### Example 1

A model cleaning composition was made with the following ingredients—see table 1. This formulation had a pH of 6.0

TABLE 1
model cleaning composition

| Ingredient | Model (wt. %) |
|---|---|
| Demin water | to 100 |
| PAS—Primary Alkyl Sulfate | as required |
| [Sodium Lauryl Sulfate (SLS)] | |
| NaOH | 0.338 |
| Citric Acid | 0.350 |
| Sodium Chloride | 0.075 |
| Rhamnolipid (RL) - (R1 or R2) | as required |
| Lauryl hydroxy sultaine (HS) | as required |

The rhamnolipid surfactant was either a mono-rhamnolipid (R1) or a di-rhamnolipid (R2).

To this model, cleaning compositions comprising 17 wt. % of total surfactant were made as per table 2

TABLE 2
showing the surfactant mixes of the cleaning compositions

| | | Ratio of | Ratio of | Krafft |
|---|---|---|---|---|
| Ingredients | Levels (wt. %) | PAS:HS | PAS:RL | Point ° C. |
| PAS | 19 | — | — | 16 |
| PAS | 17 | — | — | 16 |
| PAS | 8 | — | — | 16 |
| PAS:HS | 14:3 | 4.67:1 | — | 14 |
| PAS:R2 | 14:3 | — | 4.67:1 | 16 |
| PAS:R1 | 14:3 | — | 4.67:1 | 12 |
| PAS:HS:R2 | 11:3:3 | 3.67:1 | 3.67:1 | 9 |
| PAS:HS:R1 | 11:3:3 | 3.67:1 | 3.67:1 | 7 |
| PAS:HS:R2 | 8:4.5:4.5 | 1.78:1 | 1.78:1 | −1 |
| PAS:HS:R1 | 8:4.5:4.5 | 1.78:1 | 1.78:1 | −2 |

The results clearly show that the Krafft point of the primary alkyl sulfate is successfully reduced by the addition of the combination of an amphoteric surfactant and rhamnolipid at the specified ratios.

### Example 2

Further examples using 17 wt. % total surfactant levels were carried out.

| | | Ratio of | Ratio of | Krafft |
|---|---|---|---|---|
| Ingredients | Levels (wt. %) | PAS:HS | PAS:RL | Point ° C. |
| PAS:HS:R2 | 12.58:2.21:2.21 | 5.70:1 | 5.70:1 | 10.5 |
| PAS:HS:R2 | 8.16:4.42:4.42 | 1.85:1 | 1.85:1 | −2 |

The results clearly show that the Krafft point of the primary alkyl sulfate is successfully reduced by the addition of the combination of an amphoteric surfactant and rhamnolipid at the specified ratios.

### Example 3

A further example using ˜10 wt. % total surfactant level was carried out using a different amphoteric surfactant.

This example used cocamidopropyl betaine (CAPB) as the amphoteric surfactant.

| | | Ratio of | Ratio of | Krafft |
|---|---|---|---|---|
| Ingredients | Levels (wt. %) | PAS:CAPB | PAS:RL | Point ° C. |
| PAS:CAPB:R2 | 6.25:1.79:2 | 3.49:1 | 3.25:1 | <0° C. |

This example shows that similar results were seen using cocamidopropyl betaine as the amphoteric surfactant in the surfactant mixture.

1. A cleaning composition comprising:
a) from 1 to 30 wt. % of a primary alkyl sulfate surfactant;
b) from 1 to 10 wt. % of an amphoteric surfactant selected from betaines, glucamides, and sultaines; and,
c) from 1 to 10 wt. % of a rhamnolipid biosurfactant;
wherein a ratio of the primary alkyl sulfate surfactant to the rhamnolipid biosurfactant is from 8:1 to 1:10; and,
wherein a ratio of the primary alkyl sulfate surfactant to the amphoteric surfactant is from 8:1 to 1:10;
wherein the primary alkyl sulfate surfactant is a C₁₀-C₂₀ alkyl sulphate.

2. The composition according to claim 1, wherein the cleaning composition is a fluid cleaning composition.

3. The composition according to claim 1, wherein the cleaning composition comprises from 1 to 25 wt. % of the primary alkyl sulfate surfactant.

4. The composition according to claim 1, wherein the primary alkyl sulfate surfactant is a sodium, potassium or ammonium C₁₀-C₂₀ alkyl sulphate.

5. The composition according to claim 1, wherein the cleaning composition comprises from 1 to 9 wt. % of the rhamnolipid biosurfactant.

6. The composition according to claim 1, wherein the rhamnolipid biosurfactant comprises at least 50 wt. % mono-rhamnolipid, or least 50 wt. % di-rhamnolipid.

7. The composition according to claim 1, wherein the rhamnolipid biosurfactant is a di-rhamnolipid of formula: Rha2C₈₋₁₂ C₈₋₁₂ wherein the alkyl chain may be saturated or unsaturated.

8. The composition according to claim 1, wherein the cleaning composition comprises from 1 to 9 wt. % of the amphoteric surfactant.

9. The composition according to claim 1, wherein the amphoteric surfactant is selected from cocamidopropyl betaine, lauryl hydroxy sultaine, and mixtures thereof.

10. The composition according to claim 1, further comprising one or more enzymes selected from lipases, proteases, amylases, cellulases, and mixtures thereof.

11. The composition according to claim 1, wherein the composition is a detergent composition, and when dissolved in demineralised water at 4 g/L, 293K, has a pH of from 4 to 11.

12. A method of treating a substrate, the method comprising the steps of:
a) treating said substrate with an aqueous solution of the cleaning composition as defined in claim 1; and,
b) rinsing and drying the substrate.

13. The method according to claim 12, wherein the substrate is selected from cutlery, crockery, glassware, plastics, and metal.

14. A method of treating a textile, the method comprising the steps of:
a) treating the textile with from 1 g/L of an aqueous solution of the cleaning composition as defined in claim 1; and,
b) allowing said aqueous solution to remain in contact with the textile for a time period of from 10 minutes to 2 days, then rinsing and drying the textile.

15. (canceled)

16. The composition according to claim 1, wherein the primary alkyl sulfate surfactant is sodium lauryl sulfate.

17. The composition according to claim 1, wherein the amphoteric surfactant is lauryl hydroxy sultaine.

18. The composition according to claim 1, wherein the ratio of the primary alkyl sulfate surfactant to the rhamnolipid biosurfactant is from 7:1 to 1:5.

19. The composition according to claim 1, wherein the ratio of the primary alkyl sulfate surfactant to the rhamnolipid biosurfactant is from 6:1 to 1:2.

20. The composition according to claim 1, wherein the ratio of the primary alkyl sulfate surfactant to the amphoteric surfactant is from 7:1 to 1:5.

21. The composition according to claim 1, wherein the ratio of the primary alkyl sulfate surfactant to the amphoteric surfactant is from 6:1 to 1:2.
